(19) United States
(12) Patent Application Publication
(10) Pub. No.: US 2007/0283143 A1
(43) Pub. Date: Dec. 6, 2007

(54) System and method for certificate-based client registration via a document processing device

(75) Inventors: Sameer Yami, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/447,349

(22) Filed: Jun. 6, 2006

(51) Int. Cl. H04L 9/00

(52) U.S. Cl. 713/156; 713/173; 713/175

(57) ABSTRACT

A system and method for certificate-based client registration via a document processing device is provided. A client device, having an operating system disparate from a document processing device on a computer network, connects to the document processing device to procure a valid digital certificate. The document processing device receives authentication data from the client device, which is then verified by a trusted authentication server. The document processing device, based upon the verification by the authentication server, authenticates the certificate request made by the client device. The document processing device then forwards the authenticated certificate request to a trusted certificate server for issuance of a digital certificate. The certificate server issues the digital certificate, which is then returned to the document processing device. The digital certificate is then sent to the client device, thereby enabling the client device to request the performance of document processing operations by the document processing device.

### BACKGROUND OF THE INVENTION

The subject application is directed to a system and method for certificate-based client registration via a document processing device. More particularly, the subject application is directed to a system and method for a user to obtain a certificate to access a document processing device via the document processing device.

Frequently, users will use shared peripherals, such as document processing devices, in a network environment. It is increasingly important to maintain security during use of such shared peripherals. In a traditional network arrangement, a user logs in to a workstation that is able to request and secure a certificate that authenticates that user for access to a set of shared devices. This paradigm is often acceptable for homogenous office machine environment, such as a network system built under the Microsoft WINDOWS environment. However, many systems are more complex in nature, and include devices, such as workstations or intelligent peripherals, that operate under disparate operating environments. These include UNIX, POSIX, LINUX, and a myriad of alternative environments.

Any operating environment that does not conform to a selected network system strategy makes it difficult, or impossible, for an associated user to take advantage of security and control afforded to certificate-based network authorization privileges. It would be advantageous to have a system and method by which a network device, such as a document processing device, is able to assist a non-conforming user in securing a certificate for access to one or more network devices.

The subject application overcomes the above noted problems and provides a system and method for certificate-based client registration via a document processing device.

### SUMMARY OF THE INVENTION

In accordance with the subject application, there is provided a system and method for certificate-based client registration via a document processing device.

Further, in accordance with the subject application, there is provided a system and method for a user to obtain a certificate to access a document processing device via the document processing device.

Still further, in accordance with the subject application, there is provided a system and method by which a network device, such as a document processing device, is able to assist a non-conforming user in securing a certificate for access to one or more network devices.

Still further, in accordance with the subject application, there is provided a system for certificate-based client registration via a document processing device, wherein the system is comprised of a document processing device. The document processing device includes a document processing device network interface adapted for data communication with an associated network and means adapted for receiving a certificate request, the certificate request including identification data representative of a source of the certificate request. The device also includes means adapted for storing trusted server data representative of an identity of at least one trusted certificate server and authentication means adapted for receiving authentication data representative of an authentication of a received certificate request. The device further includes means adapted for relaying an authenticated certificate request to at least one associated trusted certificate server via the network interface so as to commence issuance of a digital certificate to an associated client therefrom.

Preferably, the associated client is at least one of a UNIX and LINUX based system, and the associated network is WINDOWS based so as to require a digital certificate to authenticate a client.

In another embodiment, the system further includes a certificate server. The certificate server includes a certificate server network interface adapted for data communication with the associated network and means adapted for receiving the authenticated certificate request from the document processing device via the certificate server network interface. The certificate server also includes means adapted for generating a digital certificate corresponding thereto and means adapted for communicating the generated digital certificate to at least one client machine corresponding to the certificate request.

In yet another embodiment, the system also comprises an authentication server, which server includes an authentication server network interface adapted for data communication with the associated network and means adapted for receiving an authentication token from the document processing device via the authentication server network interface, the authentication token corresponding to the certificate request. The authentication server also comprises means adapted for selectively authenticating a received authentication token and means adapted for communicating authentication data to the document processing device as an authenticated token.

In another embodiment, the system also includes means adapted for commencing at least one document processing operation in accordance with the generated digital certificate. Preferably, the system also includes means adapted for commencing the at least one document processing operation in accordance with an associated print server in data communication with the associated network.

In still another embodiment, the system further comprises means adapted for communicating the certificate request to the document processing device via DPWS.

Still further, in accordance with the subject application, there is provided a method for certificate-based client registration via a document processing device in accordance with the above described system.

Still other advantages, aspects and features of the subject application will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for certificate-based client registration via a document processing device according to the subject application;

FIG. 2 is a flowchart illustrating the method for certificate-based client registration via a document processing device according to the subject application; and

FIG. 3 is a flowchart illustrating the method for certificate-based client registration via a document processing device according to the subject application.

### DETAILED DESCRIPTION OF THE PREFERRED EMBODIMENT

The subject application is directed a system and method for certificate-based client registration via a document processing device. In particular, the subject application is directed to a system and method for a user to obtain a certificate to access a document processing device via the document processing device. More particularly, the subject application is directed to a system and method by which a network device, such as a document processing device, is able to assist a non-conforming user in securing a certificate for access to one or more network devices.

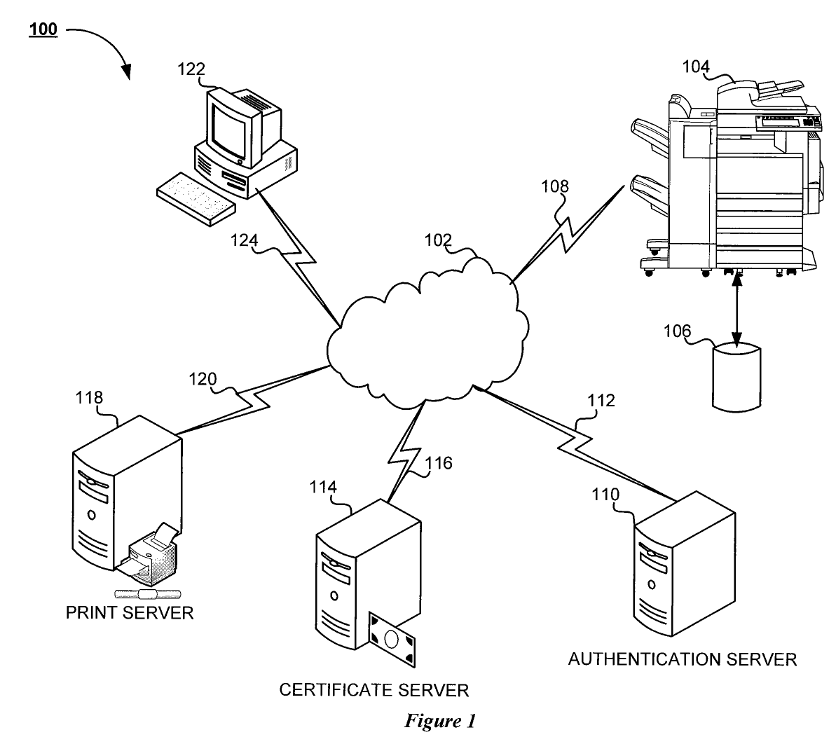

Referring now to FIG. 1, there is shown an overall diagram of a system 100 for certificate-based client registration via a document processing device in accordance with the subject application. As depicted in FIG. 1, the system 100 employs a distributed computing environment, represented as a computer network 102. It will be appreciated by the skilled artisan that the computer network 102 is any distributed communications environment known in the art capable of allowing two or more electronic devices to exchange data. Those skilled in the art will understand that the computer network 102 is any computer network, known in the art, including for example, and without limitation, a local area network, a wide area network, a personal area network, a virtual network, an intranet, the Internet, or any combination thereof. In the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wire-based or wireless data communication mechanisms.

The system 100 includes at least one document processing device 104, represented in FIG. 1 as a multifunction peripheral device. It will be understood by those skilled in the art the document processing device 104 is suitably adapted to provide a variety of document processing services, such as, for example and without limitation, electronic mail, scanning, copying, facsimile, document management, printing, and the like. Suitable commercially available document processing devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the present invention, the document processing device 104 further includes an associated user-interface, such as a touch-screen interface, LCD display, or the like, via which an associated user is able to interact directly with the document processing device 104. In accordance with the preferred embodiment of the subject application, the document processing device 104 further includes a data storage device 106, communicatively coupled to the document processing device 104, suitably adapted to provide storage of trusted certificate servers, LDAP directories, Active Directories, KERBEROS servers, and the like. As will be understood by those skilled in the art, the data storage device 106 is any mass storage device known in the art including, for example and without limitation, a hard disk drive, other magnetic storage devices, optical storage devices, flash memory devices, or any combination thereof. In one particular embodiment of the subject application, the data storage device 106 is an internal hard disk drive coupled to the document processing device 104.

In accordance with the preferred embodiment of the subject application, the document processing device 104 is in data communication with the computer network 102 via a suitable communications link 108. As will be appreciated by the skilled artisan, a suitable communications link 108 employed in accordance with the present invention includes, WiMax, 802.11a, 802.11b, 802.11 g, 802.11(x), BLUETOOTH, the public switched telephone network, a proprietary communications network, infrared, optical, or any other suitable wired or wireless data transmission communications known in the art.

As shown in FIG. 1, the system 100 also employs an authentication server 110, communicatively coupled to the computer network 102 via a communications link 112. The skilled artisan will appreciate that the authentication server 110 is any software, hardware, or combination thereof, suitably adapted to provide authentication services to the computer network 102. Preferably, the authentication server 110 advantageously provides verification of user identities, rights, passwords, and the like. As will be understood by those skilled in the art, the authentication server 110 is capable of employing any verification and authentication methods, known in the art. In one embodiment of the subject application, the authentication server 110 is suitably adapted to employ authentication tokens, as will be understood by those skilled in the art. It will be appreciated by those skilled in the art that while the authentication server 110 is illustrated in FIG. 1 as a stand-alone device, the subject application is capable of implementing the authentication server 110 as a component of a device on the computer network, e.g., a component of the document processing device 104, or the like.

The communications link 112, coupling the authentication server 110 to the computer network 102, is any suitable means of data communication known in the art, including, for example and without limitation, infrared, optical, a proprietary communications network, the public switched telephone network, BLUETOOTH, WiMax, 802.11a, 802.11b, 802.11 g, or 802.11(x), or any other suitable wire-based or wireless data transmission means known in the art. In the preferred embodiment of the subject application, the communications link 112 is suitably adapted to provide a secure communications channel between the authentication server 110 and any other electronic device coupled to the computer network 102, as will be appreciated by those skilled in the art. Preferably, the communications link 112, so as to ensure the security of the user authentication information that is verified by the authentication server 110, is implemented using data security protocols, such as web security protocols, in accordance with the subject application.

The system 100 depicted in FIG. 1 further includes at least one certificate server 114, in data communication with the computer network 102 via a communications link 116. The skilled artisan will appreciate that the certificate server 114 is any software, hardware, or combination thereof, suitably adapted to provide digital certificate services to the computer network 102. The communications link 116 is any suitable data communications channel known in the art including, for example and without limitation, 802.11(x), infrared, BLUETOOTH, a proprietary communications network, the public switched telephone network, optical, or any other suitable wire-based or wireless data transmission means known in the art. In the preferred embodiment of the subject application, the communications link 116 is suitably adapted to provide a secure communications channel between the authentication certificate server 116 and any other electronic device coupled to the computer network 102, as will be appreciated by those skilled in the art. Preferably, the communications link 116 is implemented using data security protocols, such as web security protocols, so as to ensure the security of digital certificates issued by the certificate server 114, in accordance with the subject application. It will be understood by those skilled in the art that while the certificate server 114 is illustrated in FIG. 1 as a stand-alone device communicatively coupled to the computer network, the subject application is not so limited. Thus, the skilled artisan will appreciate that the certificate server 114 is capable of being implemented as a component of a device coupled to the network, as is known in the art.

In accordance with an alternative embodiment of the subject application, the system 100 employs a print server 118 suitably adapted to facilitate the processing of document processing requests transmitted via the computer network 102 to the document processing device 104. As will be appreciated by those skilled in the art, the print server 118 is capable of implementation on a variety of different platforms, including, for example and without limitation, LINUX products, Microsoft Corporation server products, or the like. The print server 118 is capable of implementation as any hardware, software, or suitable combination thereof, able to perform the document processing operations associated therewith. It will be understood by those skilled in the art that while the print server 118 is illustrated in FIG. 1 as a stand-alone device communicatively coupled to the computer network, the subject application is not so limited. Thus, the skilled artisan will appreciate that the print server 118 is capable of being implemented as a component of a device coupled to the network, as is known in the art. In accordance with the alternative embodiment of the subject application, the print server 118 is communicatively coupled to the computer network 102 via a communications link 120. Preferably, the communications link 120 is any suitable communications channel known in the art enabling the two-way communication of data including, for example and without limitation, BLUETOOTH, a proprietary communications channel, infrared, WiMax, 802.11a, 802.11b, 802.11 g, 802.11(x), optical, the public switched telephone network, or any other suitable wire-based or wireless data transmission communications known in the art. The skilled artisan will appreciate that other server-type platforms are equally capable of being implemented in accordance with the methodologies described herein.

The system 100 illustrated in FIG. 1 further includes at least one client device 122. Preferably, the client device 122 is communicatively coupled to the computer network 102 via a suitable communications link 124. It will be appreciated by those skilled in the art that the client device 122 is depicted in FIG. 1 as a computer workstation for illustration purposes only. As the skilled artisan will understand, the client device 122 shown in FIG. 1 is representative of any personal computing device known in the art, including, for example and without limitation, a laptop computer, a personal computer, a personal data assistant, a web-enabled cellular telephone, a smart phone, or other web-enabled electronic device. In accordance with one embodiment of the subject application, the client device 122 employs a LINUX-based operating system. The skilled artisan will appreciate other operating systems, such as WINDOWS-based, Mac®-based, or the like, are equally capable of being employed by the client device 122 in accordance with the subject application. The communications link 124 is any suitable channel of data communications known in the art including, but not limited to wireless communications, for example and without limitation, BLUETOOTH, WiMax, 802.11a, 802.11b, 802.11g, 802.11(x), a proprietary communications network, infrared, optical, the public switched telephone network, or any suitable wireless data transmission system, or wired communications known in the art.

In operation, when a client device 122 desires to interact with one of the document processing devices 104 present on the computer network 102, e.g., using a device profile for web services protocol, and uses a non-WINDOWS-based operating system, the client device 122 must first procure a digital certificate. The skilled artisan will appreciate that the client device 122 is not able to automatically obtain a certificate at network logon due to the disparate operating systems of the client device 122 and the document processing device 104. Accordingly, the client device 122 generates a request for a certificate and sends this certificate request to the document processing device 104. It will be appreciated by those skilled in the art that the client device 122 sends the certificate request to the document processing device 104 in accordance with the implementation of a device profile for web services protocol (DPWS), or the like. The document processing device 104 then requests a token or authentication data from the client device 122. Preferably, the request includes a list of trusted servers/directories to which the client device 122 may have valid credentials. The client device 122, upon receipt of the authentication request, determines, for which of the servers on the trusted list the client device 122 has valid credentials, and transmits the requisite authentication data to the document processing device, i.e., authentication data corresponding to the authentication server 110.

The token or authentication data received from the client device 122 by the document processing device 104 is then sent to the authentication server 110. It will be appreciated by those skilled in the art that the document processing device 104 first determines, based upon the authentication data received from the client device 122, for which of the trusted servers the client device 122 has provided authentication data. The authentication server 110 then determines whether the data received from the document processing device 104 is valid. When the token or authentication data is invalid, the authentication server 110 returns an error notification to the document processing device, which thereafter sends a notification to the client device 122 informing the user associated therewith of the authentication error. When the token or authentication data is valid, the authentication server 110 returns the authenticated token/data to the document processing device 104.

The document processing device 104 then authenticates the digital certificate request in accordance with the authenticated token/data and selects a trusted certificate server 114 to issue the requested certificate. The authenticated certificate request is then transmitted to the identified certificate server 114, which issues the requested digital certificate. Preferably, the transmission of the authenticated certificate request is accomplished using a simple certificate enrollment protocol, or the like. The issued certificate is then transmitted from the certificate server 114 to the document processing device 104, which sends the digital certificate to the requesting client device 122. Thereafter, the client device 122 is able to generate a document processing request and transmits the request, in accordance with the digital certificate, to the document processing device 104. Depending upon the rights, accesses, and privileges stipulated by the digital certificate, the document processing device 104 selectively performs the requested document processing operation.

Stated another way, when a client device 122 uses a device profile for web services protocol to connect with the document processing device 104 and lacks a valid certificate, the user associated with the client device 122 is required to provide a valid credential, such as, for example and without limitation, a KERBEROS token or user ID/password. The document processing device 104 verifies the credentials against the authentication server 110 and allows the certificate request to be sent to the certificate server 114. The certificate server 114 then issues the requested certificate, which is returned to the document processing device 104. The certificate is then sent to the requesting client by the document processing device 104.

In accordance with an alternative embodiment of the subject application, the print server 118 is employed to facilitate the operations of the document processing device 104. In such an embodiment, the certificate issued by the certificate server 114 is transmitted from the document processing device 104 to the print server 118 via any suitable means known in the art. It will be understood by those skilled in the art that such a use of the print server 118 enables the client device 122 to submit a document processing request to the print server 118 and allows the print server 118 to determine which of the available document processing devices (i.e., device 104), is to be used to process the request. The print server 118 then functions to facilitate the output of the requested document processing operation, the communication of the certificate to the client device 122, and other operations, as are known in the art to be associated with operations of a print server.

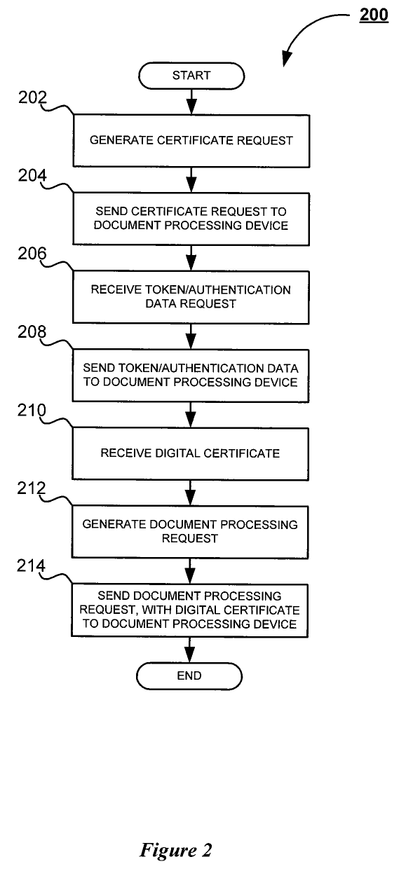

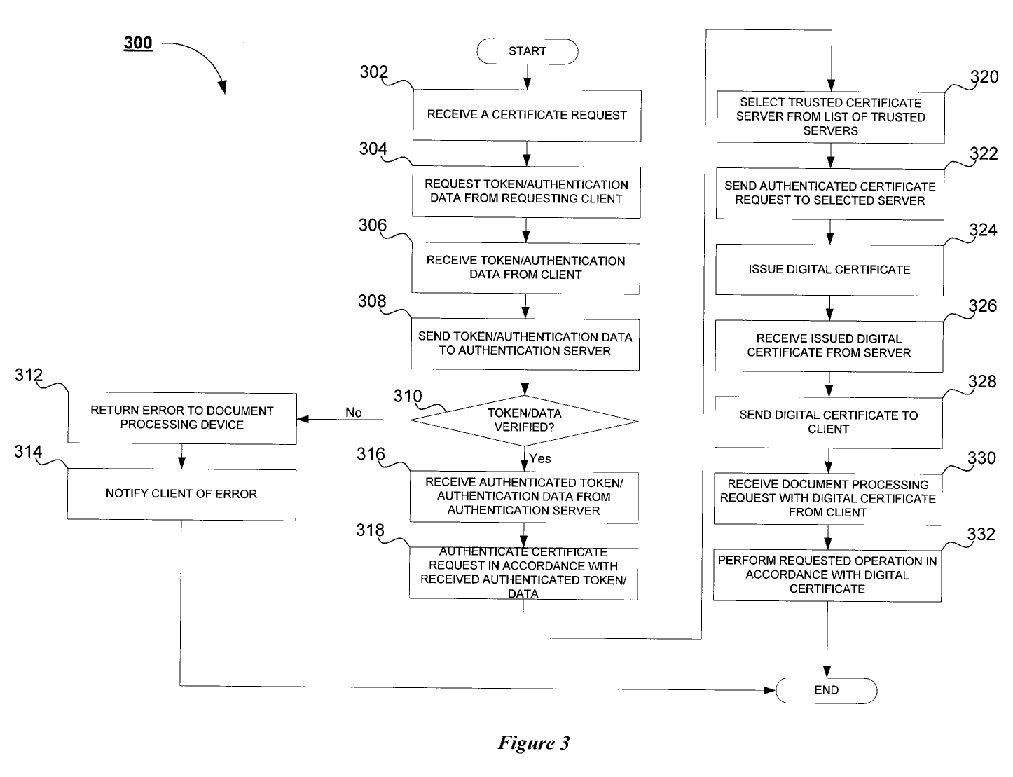

The foregoing system 100 will better be understood when viewed in conjunction with the methodologies set forth in FIG. 2 and FIG. 3, discussed hereinafter. Turning now to FIG. 2, there is shown a flowchart 200 illustrating a method for certificate-based client registration via a document processing device in accordance with the subject application. Beginning at step 202, the client device 122 initiates a registration process by generating a certificate request. This certificate request is then transmitted, via a suitable communications channel, to the document processing device 104 at step 204. It will be appreciated by those skilled in the art that the client device 122 sends the certificate request to the document processing device 104 in accordance with the implementation of a device profile for web services protocol (DPWS), or the like. The client device 122 then receives a request for authentication data or an authentication token from the document processing device 104 at step 206. It will be understood by those skilled in the art that the authentication data or token requested by the document processing device includes, for example and without limitation, a user ID/password, a KERBEROS ticket, or the like. Preferably, the request for authentication data or token includes a listing of Active Directory, LDAP, KERBEROS KDC, or other authentication servers known and/or trusted by the document processing device 104, whereby the document processing device 104 is capable of verifying the client device 122.

The client device 122 then sends, at step 208, the requested authentication token or data to the document processing device 104. The client device 122 then waits until step 210, whereupon a digital certificate is received from the document processing device 104. The methodology of issuing the digital certificate will be explained in greater detail below with respect to FIG. 3. Once the client device 122 has received the digital certificate, at step 210, flow proceeds to step 212, whereupon the client device 122 generates a document processing request. The document processing request, along with the digital certificate, is then transmitted, via any suitable means known in the art to the document processing device 104 for output thereon.

Referring now to FIG. 3, there is shown a flowchart 300 illustrating the method for certificate-based client registration via a document processing device in accordance with the subject application. Beginning at step 302, the document processing device 104 receives a registration request inclusive of a certificate request from the client device 122. The document processing device 104 then retrieves a listing of authentication means, such as, for example and without limitation, an Active Directory, LDAP, KERBEROS KDC, or the like, known and trusted by the document processing device 104 from the associated data storage device 106. It will be understood by those skilled in the art that the foregoing servers are representative of common authentication servers and/or directories and are used herein for example purposes only, as the subject application is not so limited. In accordance with the preferred embodiment, this listing of trusted servers/directories is incorporated into a request for authentication data or an authentication token, which is transmitted to the requesting client device 122 at step 304.

The document processing device 104 then receives, at step 306, authentication data or an authentication token from the client device 122 associated with one of the servers/directories known or trusted by the document processing device 104. The skilled artisan will appreciate that the authentication data or token is used by the document processing device 104 to verify the identity of the client device 122 as authenticated by a server or directory which the document processing device 104 trusts. To that end, at step 308 the received token or authentication data is transmitted, via any suitable secure means known in the art, to the authentication server 110. It will be understood by those skilled in the art that the client device 122 has selected one of the servers/directories included in the request for authentication data and the response received from the client device 122 includes data representative of the selected authentication means. Preferably, the document processing device 104 is suitably adapted to ascertain the identity of the selected authentication means, e.g., the authentication server 110, based upon the token or authentication data received from the client device 122.

The received authentication data or authentication token has thus been transmitted, at step 308, to the identified authentication means, e.g., authentication server 110, for verification of the client device 122. When the authentication server 110 determines at step 310 that the token or authentication data is not verifiable, an error notification is returned to the document processing device 104 at step 312. The document processing device 104 then sends a notification of the problems in verification of the authentication data or token to the requesting client device 122 at step 314, thereby terminating the registration process.

When it is determined at step 310 that the authentication data, or the authentication token, supplied by the client device 122 is valid, the authentication server 110 returns an authenticated data or token to the document processing device 104 at step 316. Thereafter, the document processing device 104 authenticates the certificate request in accordance with the received authenticated data or token at step 318. Next, at step 320, the document processing device 104 retrieves a listing of trusted certificate servers, e.g., certificate server 114, from the data storage device 106 and selects a trusted certificate server 114 to issue the requested digital certificate. At step 322, the authenticated certificate request is transmitted to the trusted certificate server 114 via a secure communications channel, as will be appreciated by those skilled in the art. Preferably, the document processing device 104, functioning herein as a proxy, forwards the certificate request to the certificate server 114 using suitable protocols, including for example and without limitation, simple certificate enrollment protocol, and the like.

In accordance with the preferred embodiment of the subject application, the certificate server 114 uses the received authenticated request to generate a digital certificate corresponding thereto, which is issued by the server 114 at step 324. The issued digital certificate is then transmitted via a suitable communications channel, whereupon it is received at step 326 by the requesting document processing device 104. At step 328 the digital certificate is sent to the requesting client device 122 via any suitable means known in the art. The skilled artisan will appreciate that step 328 signifies the termination of the registration/certificate issuance proxy operation of the document processing device 104 with respect to the client device 122. Thereafter, the document processing device 104 receives, from the client device 122, a document processing request inclusive of data representative of the digital certificate at step 330. Depending upon the rights, access, privileges, or the like associated with the digital certificate, the document processing device 104 performs the document processing operations of the request.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for certificate-based client registration via a document processing device comprising:
a document processing device including,
a document processing device network interface adapted for data communication with an associated network;
means adapted for receiving a certificate request, the certificate request including identification data representative of a source of the certificate request;
means adapted for storing trusted server data representative of an identity of at least one trusted certificate server,
authentication means adapted for receiving authentication data representative of an authentication of a received certificate request, and
means adapted for relaying an authenticated certificate request to at least one associated trusted certificate server via the network interface so as to commence issuance of a digital certificate to an associated client therefrom.

2. The system for certificate-based client registration via a document processing device of claim 1 further comprising a certificate server including:
a certificate server network interface adapted for data communication with the associated network;
means adapted for receiving the authenticated certificate request from the document processing device via the certificate server network interface;
means adapted for generating a digital certificate corresponding thereto; and
means adapted for communicating the generated digital certificate to at least one client machine corresponding to the certificate request.

3. The system for certificate-based client registration via a document processing device of claim 2 further comprising an authentication server including:
an authentication server network interface adapted for data communication with the associated network;
means adapted for receiving an authentication token from the document processing device via the authentication server network interface, the authentication token corresponding to the certificate request;
means adapted for selectively authenticating a received authentication token; and
means adapted for communicating authentication data to the document processing device as an authenticated token.

4. The system for certificate-based client registration via a document processing device of claim 3 further comprising means adapted for commencing at least one document processing operation in accordance with the generated digital certificate.

5. The system for certificate-based client registration via a document processing device of claim 4 further comprising means adapted for communicating the certificate request to the document processing device via DPWS.

6. The system for certificate-based client registration via a document processing device of claim 5 wherein the associated client is at least one of a UNIX and Linux based system, and wherein the associated network is WINDOWS based so as to require a digital certificate to authenticate a client.

7. The system for certificate-based client registration via a document processing device of claim 4 further comprising means adapted for completing the at least one document processing operation in accordance with an associated print server in data communication with the associated network.

8. A method for certificate-based client registration via a document processing device comprising the steps of:
communicating, via a document processing device network interface, with an associated network,
receiving a certificate request, the certificate request including identification data representative of a source of the certificate request;
storing trusted server data representative of an identity of at least one trusted certificate server,
receiving authentication data representative of an authentication of a received certificate request, and
relaying an authenticated certificate request to at least one associated trusted certificate server via the network interface so as to commence issuance of a digital certificate to an associated client therefrom.

9. The method for certificate-based client registration via a document processing device of claim 8 further comprising the steps of:
communicating, via a certificate server network interface, with the associated network;
receiving the authenticated certificate request from the document processing device via the certificate server network interface;
generating a digital certificate corresponding thereto; and
communicating the generated digital certificate to at least one client machine corresponding to the certificate request.

10. The method for certificate-based client registration via a document processing device of claim 9 further comprising the steps of:
communicating, via an authentication server network interface, with the associated network;
receiving an authentication token from the document processing device via the authentication server network interface, the authentication token corresponding to the certificate request;
selectively authenticating a received authentication token; and
communicating authentication data to the document processing device as an authenticated token.

11. The method for certificate-based client registration via a document processing device of claim 10 further comprising the step of commencing at least one document processing operation in accordance with the generated digital certificate.

12. The method for certificate-based client registration via a document processing device of claim 11 further comprising the step of communicating the certificate request to the document processing device via DPWS.

13. The method for certificate-based client registration via a document processing device of claim 12 wherein the associated client is at least one of a UNIX and based system, and wherein the associated network is WINDOWS based so as to require a digital certificate to authenticate a client.

14. The method for certificate-based client registration via a document processing device of claim 11 further comprising the step of completing the at least one document processing operation in accordance with an associated print server in data communication with the associated network.

15. A computer-implemented method for certificate-based client registration via a document processing device comprising the steps of:
communicating, via a document processing device network interface, with an associated network,
receiving a certificate request, the certificate request including identification data representative of a source of the certificate request;
storing trusted server data representative of an identity of at least one trusted certificate server,
receiving authentication data representative of an authentication of a received certificate request, and
relaying an authenticated certificate request to at least one associated trusted certificate server via the network interface so as to commence issuance of a digital certificate to an associated client therefrom.

16. The computer-implemented method for certificate-based client registration via a document processing device of claim 15 further comprising the steps of:
communicating, via a certificate server network interface, with the associated network;
receiving the authenticated certificate request from the document processing device via the certificate server network interface;
generating a digital certificate corresponding thereto; and
communicating the generated digital certificate to at least one client machine corresponding to the certificate request.

17. The computer-implemented method for certificate-based client registration via a document processing device of claim 16 further comprising the steps of:
communicating, via an authentication server network interface, with the associated network;
receiving an authentication token from the document processing device via the authentication server network interface, the authentication token corresponding to the certificate request;
selectively authenticating a received authentication token; and
communicating authentication data to the document processing device as an authenticated token.

18. The method for certificate-based client registration via a document processing device of claim 10 further comprising the step of commencing at least one document processing operation in accordance with the generated digital certificate.

19. The computer-implemented method for certificate-based client registration via a document processing device of claim 18 further comprising the step of communicating the certificate request to the document processing device via DPWS.

20. The computer-implemented method for certificate-based client registration via a document processing device of claim 19 wherein the associated client is at least one of a UNIX and based system, and wherein the associated network is WINDOWS based so as to require a digital certificate to authenticate a client.
